(19) United States
(12) Patent Application Publication
(10) Pub. No.: US 2020/0267363 A1
(43) Pub. Date: Aug. 20, 2020

(54) DATA PROCESSING METHOD, DATA SENDING END, DATA RECEIVING END, AND COMMUNICATION SYSTEM

(71) Applicant: SZ DJI TECHNOLOGY CO., LTD., Shenzhen (CN)

(72) Inventors: Xueyi CHEN, Shenzhen (CN); Qian XIE, Shenzhen (CN); Xiangming ZHU, Shenzhen (CN)

(21) Appl. No.: 16/867,980

(22) Filed: May 6, 2020

Related U.S. Application Data
(63) Continuation of application No. PCT/CN2017/109707, filed on Nov. 7, 2017.

(51) Int. Cl. H04N 11/20; H04N 11/08; H04N 9/64

(52) U.S. Cl. CPC H04N 11/20; H04N 9/64; H04N 11/08

(57) ABSTRACT

A data processing method includes mapping original data in ARGB format into mapped data in RGB format, and sending the mapped data to a data receiving terminal through a first display serial interface (DSI) for the data receiving terminal to receive the mapped data through a second DSI and to inversely map the mapped data to obtain the original data.

### CROSS-REFERENCE TO RELATED APPLICATION

This application is a continuation of International Application No. PCT/CN2017/109707, filed Nov. 7, 2017, the entire content of which is incorporated herein by reference.

### TECHNICAL FIELD

The present disclosure relates to data processing and, more particularly, to a data processing method, a data sending end (“data sending terminal” or “data transmitter”), a data receiving end (“data receiving terminal” or “data receiver”), and a communication system.

### BACKGROUND

Display Serial Interface (DSI) is a serial interface for transmitting display data defined by the MIPI Alliance, and is widely used in image display devices with LCD screens, such as smartphones, remote controllers for unmanned aerial vehicles, and etc. The data formats that DSI supports include: YUV and RGB. However, in addition to data in the above formats, data in ARGB format sometimes needs to be transmitted by a DSI in actual applications. Since DSI does not support the transmission of the data in ARGB format, another interface different from DSI needs to be used to transmit the data in ARGB format when needed. Therefore, in order to transmit both data in YUV and RGB format and data in ARGB format, the data sending terminal and the data receiving terminal each include two kinds of interface, which makes the structures of the data sending terminal and the data receiving terminal relatively complex.

### SUMMARY

In accordance with the disclosure, there is provided a data processing method including mapping original data in ARGB format into mapped data in RGB format; and sending the mapped data to a data receiving terminal through a first display serial interface (DSI) for the data receiving terminal to receive the mapped data through a second DSI and to inversely map the mapped data to obtain the original data.

Also in accordance with the disclosure, there is provided a data processing method including receiving mapped data in RGB format sent by a data sending terminal through a first DSI of the data sending terminal. The mapped data is received through a second DSI of a data receiving terminal. The method further includes inversely mapping the mapped data into original data in ARGB format.

Also in accordance with the disclosure, there is provided a data sending terminal including a first DSI, and a processor coupled to the first SDI and configured to map original data in ARGB format into mapped data in RGB format and send the mapped data to a data receiving terminal through the first DSI for the data receiving terminal to receive the mapped data through a second DSI and to inversely map the mapped data to obtain the original data.

Also in accordance with the disclosure, there is provided a data receiving terminal coupled to a data sending terminal including a first DSI. The data receiving terminal includes a second DSI, and a processor coupled to the second DSI and configured to receive, through the second DSI, mapped data in RGB format sent by the data sending terminal through the first DSI of the data sending terminal, and inversely map the mapped data into original data in ARGB format.

Also in accordance with the disclosure, there is provided a communication system including the above data sending terminal and the above data receiving terminal.

### BRIEF DESCRIPTION OF THE DRAWINGS

FIG. 1 is a schematic flow chart of a data processing method according to an example embodiment.

FIG. 2 is a schematic flow chart of a data processing method according to another example embodiment.

FIG. 3 is a schematic flow chart of a data processing method according to another example embodiment.

FIG. 4 is a schematic structural diagram of a data sending terminal according to an example embodiment.

FIG. 5 is a schematic structural diagram of a data receiving terminal according to an example embodiment.

### DETAILED DESCRIPTION OF THE EMBODIMENTS

Embodiments in this specification are described in a progressive manner. Each embodiment focuses on the differences from other embodiments, and for the same or similar parts among various embodiments, reference can be made to each other.

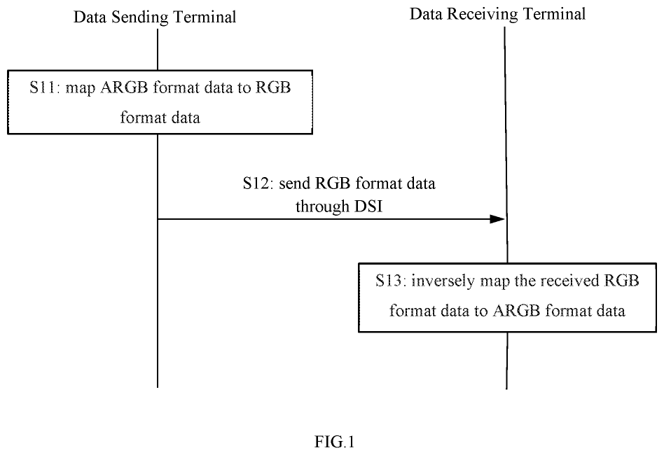

FIG. 1 is a schematic flow chart of an example data processing method consistent with the disclosure. As shown in FIG. 1, at S11, a data sending terminal maps data in ARGB format to data in RGB format. In this disclosure, the data being mapped is also referred to as “original data” and data obtained by mapping is also referred to as “mapped data.”

When a display serial interface (DSI) link transmits data in RGB format (also referred to as “RGB format data” or simply “RGB data,” where R, G, and B stand for red, green, and blue, respectively), 3 bytes (24 bits) are transmitted in one clock cycle. However, data in ARGB format (also referred to as “ARGB format data” or “ARGB data,” where A stands for alpha) includes 4 bytes (a total of 32 bits) in one clock cycle, and hence the DSI link cannot be used to transmit ARGB format data. Thus, in the embodiment of the present disclosure, data in ARGB format is converted into data conforming to RGB format.

At S12, the data sending terminal sends the mapped RGB format data to the data receiving terminal through a DSI.

The data sending terminal and the data receiving terminal communicate data in RGB format through DSIs. Hereinafter, the DSI at the data sending terminal is referred to as a first DSI, the DSI at the data receiving terminal is referred to as a second DSI, and a DSI link is formed between between the first DSI and the second DSI.

At S13, after the data receiving terminal receives the RGB format data through the DSI, the data receiving terminal inversely maps the received RGB format data into ARGB format data.

In order to restore the RGB data to the ARGB format data, the process of inversely mapping the RGB format data to the ARGB format data by the data receiving terminal keeps inversely consistent with the process of mapping the ARGB format data to the RGB format data by the data sending terminal.

Before the transmission of the data in ARGB format, the data sending terminal and data receiving terminal can negotiate to determine how the data sending terminal maps the ARGB format data to RGB format data, so that the process of inversely mapping the RGB format data to the ARGB format data by the data receiving terminal can be inversely consistent with the process of mapping the ARGB format data to the RGB format data by the data sending terminal.

In the embodiments of the present disclosure, the data sending terminal and the data receiving terminal may be two independent electronic devices, or two chips that communicate with each other in an electronic device, for example, two cascaded Systems-on-Chip (SoCs) in an electronic device.

In the data processing method provided in this disclosure, when a data sending terminal needs to send data in an ARGB format, the data sending terminal maps the data in ARGB format into the data in RGB format, and then sends the mapped data in RGB format through the first DSI. After the data receiving terminal receives the data in RGB format through the second DSI, the data receiving terminal restores the data in RGB format to data in ARGB format. As such, transmission of data in ARGB format through the DSI link is realized. Therefore, the number of interfaces used for sending image display data between the data receiving terminal and the data sending terminal is reduced, and the structures of the data sending terminal and the data receiving terminal are simplified. As a result, more functions can be developed at the data sending terminal and the data receiving terminal.

In some embodiments, mapping data in ARGB format to data in RGB format can include converting every 3 pieces of data in ARGB format into 4 pieces of data in RGB format.

For example, 3 pieces of data in ARGB format include a total of 12 bytes, which can be permutated into 4 pieces of data including three bytes for each. Table 1 shows 24 examples of converting 3 pieces of ARGB format data into 4 pieces of RGB format data. The methods of converting 3 pieces of ARGB format data into 4 pieces of RGB format data are not limited to the 24 examples listed in Table 1. There are more based on the permutations of 12 bytes, which will not be listed one by one in this disclosure.

In some embodiments, at the end of the transmission of the data in ARGB format, if the number of remaining pieces of untransmitted ARGB format data is s and s is less than 3, the data sending terminal will obtain k pieces of ARGB format data (padding ARGB data) each having a specific value, and combine the k pieces of ARGB format data with the remaining s pieces of ARGB format data, resulting in 3 pieces of ARGB format data. In another word, k+s=3 (k and s are both positive integers smaller than 3). Then these 3 pieces of data in ARGB format will be converted into 4 pieces of data in RGB format.

TABLE 1

| | ARGB_ | ARGB_ | ARGB_ | | RGB_ | RGB_ | RGB_ | RGB_ |
|---|---|---|---|---|---|---|---|---|
| | Data_0 | Data_1 | Data_2 | | Data_0 | Data_1 | Data_2 | Data_3 |
| 1 | A₀R₀G₀B₀ | A₁R₁G₁B₁ | A₂R₂G₂B₂ | → | A₀R₀G₀ | B₀A₁R₁ | G₁B₁A₂ | R₂G₂B₂ |
| 2 | A₀R₀G₀B₀ | A₁R₁G₁B₁ | A₂R₂G₂B₂ | → | A₀R₀B₀ | G₀A₁R₁ | B₁G₁A₂ | R₂G₂B₂ |
| 3 | A₀R₀G₀B₀ | A₁R₁G₁B₁ | A₂R₂G₂B₂ | → | A₀G₀B₀ | R₀A₁G₁ | B₁R₁A₂ | G₂B₂R₂ |
| 4 | A₀R₀G₀B₀ | A₁R₁G₁B₁ | A₂R₂G₂B₂ | → | A₀G₀R₀ | B₀A₁G₁ | R₁B₁A₂ | G₂R₂B₂ |
| 5 | A₀R₀G₀B₀ | A₁R₁G₁B₁ | A₂R₂G₂B₂ | → | A₀B₀R₀ | G₀A₁B₁ | R₁G₁A₂ | B₂R₂G₂ |
| 6 | A₀R₀G₀B₀ | A₁R₁G₁B₁ | A₂R₂G₂B₂ | → | A₀B₀G₀ | R₀A₁B₁ | G₁R₁A₂ | B₂G₂R₂ |
| 7 | A₀R₀G₀B₀ | A₁R₁G₁B₁ | A₂R₂G₂B₂ | → | R₀A₀B₀ | G₀R₁A₁ | B₁G₁R₂ | A₂B₂G₂ |
| 8 | A₀R₀G₀B₀ | A₁R₁G₁B₁ | A₂R₂G₂B₂ | → | R₀A₀G₀ | B₀R₁A₁ | G₁B₁R₂ | A₂G₂B₂ |
| 9 | A₀R₀G₀B₀ | A₁R₁G₁B₁ | A₂R₂G₂B₂ | → | R₀B₀G₀ | A₀R₁B₁ | G₁A₁R₂ | B₂G₂A₂ |
| 10 | A₀R₀G₀B₀ | A₁R₁G₁B₁ | A₂R₂G₂B₂ | → | R₀B₀A₀ | G₀R₁B₁ | A₁G₁R₂ | B₂A₂G₂ |
| 11 | A₀R₀G₀B₀ | A₁R₁G₁B₁ | A₂R₂G₂B₂ | → | R₀G₀B₀ | A₀R₁G₁ | B₁A₁R₂ | G₂B₂A₂ |
| 12 | A₀R₀G₀B₀ | A₁R₁G₁B₁ | A₂R₂G₂B₂ | → | R₀G₀A₀ | B₀R₁G₁ | A₁B₁R₂ | G₂A₂B₂ |
| 13 | A₀R₀G₀B₀ | A₁R₁G₁B₁ | A₂R₂G₂B₂ | → | G₀R₀B₀ | A₀G₁R₁ | B₁A₁G₂ | R₂B₂A₂ |
| 14 | A₀R₀G₀B₀ | A₁R₁G₁B₁ | A₂R₂G₂B₂ | → | G₀R₀A₀ | B₀G₁R₁ | A₁B₁G₂ | R₂A₂B₂ |
| 15 | A₀R₀G₀B₀ | A₁R₁G₁B₁ | A₂R₂G₂B₂ | → | G₀B₀R₀ | A₀G₁B₁ | R₁A₁G₂ | B₂R₂A₂ |
| 16 | A₀R₀G₀B₀ | A₁R₁G₁B₁ | A₂R₂G₂B₂ | → | G₀B₀A₀ | R₀G₁B₁ | R₁A₁G₂ | B₂A₂R₂ |
| 17 | A₀R₀G₀B₀ | A₁R₁G₁B₁ | A₂R₂G₂B₂ | → | G₀R₀A₀ | B₀G₁R₁ | A₁B₁G₂ | R₂B₂A₂ |
| 18 | A₀R₀G₀B₀ | A₁R₁G₁B₁ | A₂R₂G₂B₂ | → | G₀R₀B₀ | A₀G₁R₁ | B₁A₁G₂ | R₂B₂A₂ |
| 19 | A₀R₀G₀B₀ | A₁R₁G₁B₁ | A₂R₂G₂B₂ | → | B₀R₀A₀ | G₀B₁R₁ | A₁G₁B₂ | R₂A₂G₂ |
| 20 | A₀R₀G₀B₀ | A₁R₁G₁B₁ | A₂R₂G₂B₂ | → | B₀R₀G₀ | A₀B₁R₁ | G₁A₁B₂ | R₂G₂A₂ |
| 21 | A₀R₀G₀B₀ | A₁R₁G₁B₁ | A₂R₂G₂B₂ | → | B₀G₀R₀ | A₀B₁G₁ | R₁A₁B₂ | R₂A₂G₂ |
| 22 | A₀R₀G₀B₀ | A₁R₁G₁B₁ | A₂R₂G₂B₂ | → | B₀G₀A₀ | R₀B₁G₁ | A₁R₁B₂ | G₂A₂R₂ |
| 23 | A₀R₀G₀B₀ | A₁R₁G₁B₁ | A₂R₂G₂B₂ | → | B₀A₀R₀ | G₀B₁A₁ | R₁G₁B₂ | A₂R₂G₂ |
| 24 | A₀R₀G₀B₀ | A₁R₁G₁B₁ | A₂R₂G₂B₂ | → | B₀A₀G₀ | R₀B₁A₁ | G₁R₁B₂ | A₂G₂R₂ |

Correspondingly, after the data receiving terminal receives the last 4 pieces of RGB format data, and if the ARGB format data obtained from the last 4 pieces of RGB format data have specific value, the ARGB format data with the specific value will be deleted (discarded).

In some embodiments, the data in ARGB format with specific value can be data in ARGB format with a value of zero.

In some embodiments, when the data sending terminal forms 3 pieces of ARGB format data by combining k pieces of ARGB format data with specific value and the remaining s pieces of ARGB format data, and converts these 3 pieces of ARGB format data into 4 pieces of RGB format data, the above k pieces of ARGB format data with specific value can be used as the k pieces of ARGB format data at the tail of the formed 3 pieces of ARGB format data. Then the formed 3 pieces of ARGB format data can be converted into the 4 pieces of RGB format data.

For example, it is assumed that the ARGB format data with a specific value is ARGB₀. At the end of the transmission, there remain 2 pieces of data in ARGB format, which are ARGB₁ and ARGB₂. During the transmission of the ARGB format data stream, ARGB₁ is in front of ARGB₂, which means that ARGB₁ will be first transmitted to the mapping module (the mapping module is configured to map ARGB format data to RGB format data), and then ARGB₂ will be transmitted to the above mapping module afterwards. Therefore, when ARGB₀, ARGB₁, and ARGB₂ need to be mapped to data in RGB format, ARGB₁ will be transmitted to the above mapping module first, and then ARGB₂ will be transmitted to the above mapping module, and at last ARGB₀ will be transmitted to the above mapping module.

Correspondingly, after the data receiving terminal receives the last 4 pieces of RGB format data, and if the k pieces of ARGB format data at the tail of the converted 3 pieces of ARGB format data have specific value, the k pieces of ARGB format data having the specific value will be deleted (discarded).

The k pieces of ARGB format data having the specific value at the tail of the 3 pieces of ARGB format data include a last one of the 3 pieces of ARGB format data having the specific value or the last two of the 3 pieces of ARGB format data having the specific value.

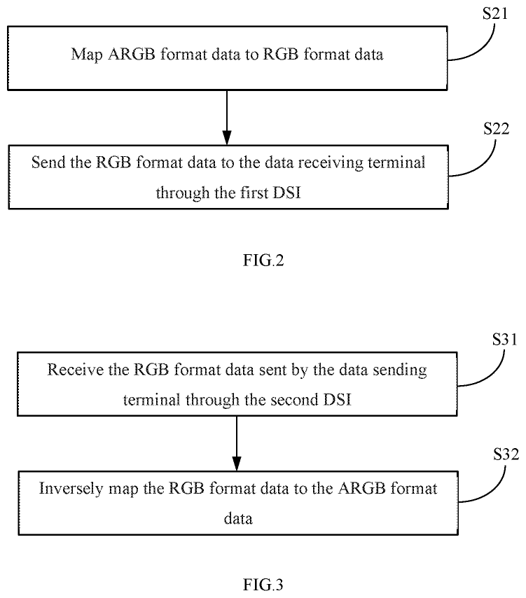

FIG. 2 is a schematic flow chart of another example data processing method consistent with the disclosure. The data processing method shown in FIG. 2 can be implemented in, e.g., the data sending terminal.

As shown in FIG. 2, at S21, data in the ARGB format is mapped to data in the RGB format.

At S22, the RGB format data is sent to a data receiving terminal through the first DSI. The data receiving terminal receives the data in the RGB format through the second DSI, and then inversely maps the received data in RGB format into data in ARGB format.

The process of inversely mapping the RGB format data to the ARGB format data by the data receiving terminal is inversely consistent with the process of mapping the ARGB format data to the RGB format data by the data sending terminal, so that the RGB format data can be restored to the ARGB format data.

In the embodiments of the present disclosure, the data sending terminal and the data receiving terminal may be two independent electronic devices, or two chips that communicate with each other in an electronic device, for example, two cascaded Systems-on-Chip (SoCs) in an electronic device.

In the data processing method provided in this disclosure, when a data sending terminal needs to send data in an ARGB format, the data sending terminal maps the data in ARGB format into the data in RGB format, and then sends the mapped data in RGB format through the first DSI. After the data receiving terminal receives the data in RGB format through the second DSI, the data receiving terminal restores the data in RGB format to data in ARGB format. As such, transmission of data in ARGB format through the DSI link is realized. Therefore, the number of interfaces used for sending image display data between the data receiving terminal and the data sending terminal is reduced, and the structures of the data sending terminal and the data receiving terminal are simplified. As a result, more functions can be developed at the data sending terminal and the data receiving terminal.

In some embodiments, mapping data in ARGB format to data in RGB format can include converting every 3 pieces of data in ARGB format into 4 pieces of data in RGB format.

In some embodiments, if the number of pieces of ARGB format data is s and s is less than 3, k pieces of ARGB format data each having specific value will be obtained. The k pieces of ARGB format data and the above s pieces of ARGB format data will be converted into 4 pieces of data in RGB format, where k+s=3 (k and s are both positive integers smaller than 3).

In some embodiments, the data in ARGB format with specific value can be data in ARGB format with a value of zero.

In some embodiments, 3 pieces of ARGB format data are formed by combining k pieces of ARGB format data with specific value and the remaining s pieces of ARGB format data. When these 3 pieces of ARGB format data are converted into 4 pieces of RGB format data, the above k pieces of ARGB format data with specific value can be used as the k pieces of ARGB format data at the tail of the formed 3 pieces of ARGB format data. Then the formed 3 pieces of ARGB format data can be converted into 4 pieces of RGB format data.

FIG. 3 is a schematic flow chart of another example data processing method consistent with the disclosure. The data processing method shown in FIG. 3 can be implemented in, e.g. the data receiving terminal.

As shown in FIG. 3, at S31, the RGB format data sent by the data sending terminal is received through the second DSI. The RGB format data is obtained by mapping the ARGB format data by the data sending terminal.

At S32, data in RGB format is inversely mapped to data in ARGB format.

The process of inversely mapping the RGB format data to the ARGB format data by the data receiving terminal is inversely consistent with the process of mapping the ARGB format data to the RGB format data by the data sending terminal, so that the RGB format data can be restored to the ARGB format data.

In the embodiments of the present disclosure, the data sending terminal and the data receiving terminal may be two independent electronic devices, or two chips that communicate with each other in an electronic device, for example, two cascaded Systems-on-Chip (SoCs) in an electronic device.

In the data processing method provided in this disclosure, when a data sending terminal needs to send data in an ARGB format, the data sending terminal maps the data in ARGB format into the data in RGB format, and then sends the mapped data in RGB format through the first DSI. After the data receiving terminal receives the data in RGB format through the second DSI, the data receiving terminal restores the data in RGB format to data in ARGB format. As such, transmission of data in ARGB format through the DSI link is realized. Therefore, the number of interfaces used for sending image display data between the data receiving terminal and the data sending terminal is reduced, and the structures of the data sending terminal and the data receiving terminal are simplified. As a result, more functions can be developed at the data sending terminal and the data receiving terminal.

In some embodiments, inversely mapping data in RGB format to data in ARGB format can include converting every 4 pieces of data in RGB format into 3 pieces of data in ARGB format.

In some embodiments, if the ARGB format data obtained from the last 4 pieces of RGB format data have specific value, the ARGB format data with the specific value will be deleted (discarded).

In some embodiments, the data in ARGB format with specific value include data in ARGB format with a value of zero.

In some embodiments, after receiving the last 4 pieces of RGB format data, and if the k pieces of ARGB format data at the tail of the converted 3 pieces of ARGB format data have specific value, the k pieces of ARGB format data having the specific value will be deleted (discarded), where k is less than 3.

The k pieces of ARGB format data having specific value at the tail of the 3 pieces of ARGB format data include the last one of the 3 pieces of ARGB format data having the specific value or the last two of the 3 pieces of ARGB format data having the specific value.

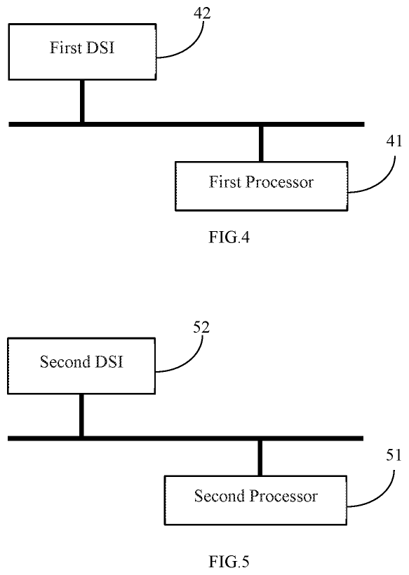

Corresponding to the method embodiments, the present disclosure further provides a data sending terminal. FIG. 4 is a schematic structural diagram of an example data sending terminal consistent with the present disclosure. As shown in FIG. 4, the data sending terminal includes a first processor 41 and a first DSI 42 coupled to the first processor 41.

The first processor 41 is configured to map the data in ARGB format to data in RGB format, and send the mapped data in RGB format to the data receiving terminal through the first DSI 42. The data receiving terminal is configured to receive the data in RGB format through the second DSI and inversely map the received data in RGB format to data in ARGB format.

The process of inversely mapping the RGB format data to the ARGB format data by the data receiving terminal is inversely consistent with the process of mapping the ARGB format data to the RGB format data by the data sending terminal, so that the RGB format data can be restored to the ARGB format data.

In the embodiments of the present disclosure, the data sending terminal and the data receiving terminal may be two independent electronic devices, or two chips that communicate with each other in an electronic device, for example, two cascaded Systems-on-Chip (SoCs) in an electronic device.

When a data sending terminal provided in this disclosure needs to send data in an ARGB format, the data sending terminal maps the data in ARGB format into data in RGB format, and then sends the mapped data in RGB format through the first DSI. After the data receiving terminal receives the data in RGB format through the second DSI, the data receiving terminal restores the data in RGB format to data in ARGB format. As such, transmission of data in ARGB format through the DSI link is realized. Therefore, the number of interfaces used for sending image display data between the data receiving terminal and the data sending terminal is reduced, and the structures of the data sending terminal and the data receiving terminal are simplified. As a result, more functions can be developed at the data sending terminal and the data receiving terminal.

In some embodiments, the first processor 41 is further configured to, when mapping the data in ARGB format to data in RGB format, convert every 3 pieces of data in ARGB format into 4 pieces of data in RGB format.

In some embodiments, if the number of piece of ARGB format data is s and s is less than 3, the first processor 41 obtains k pieces of ARGB format data each having specific value and converts the k pieces of ARGB format data and the above s pieces of ARGB format data into 4 pieces of data in RGB format, where k+s=3 (k and s are both positive integers smaller than 3).

In some embodiments, the above data in ARGB format with specific value can be data in ARGB format with a value of zero.

In some embodiments, the first processor 41 arranges the k pieces of ARGB format data with specific value as k pieces of data at the tail of the formed 3 pieces of ARGB format data, and converts the formed 3 pieces of ARGB format data into 4 pieces of RGB format data.

Corresponding to the method embodiments, the present disclosure further provides a data receiving terminal. FIG. 5 is a schematic structural diagram of an example data receiving terminal consistent with the present disclosure. As shown in FIG. 5, the data receiving terminal includes a second processor 51 and a second DSI 52 coupled to the second processor 51.

The second processor 51 is configured to receive the data in RGB format sent by the data sending terminal through the second DSI 52 and inversely map the received data in RGB format to data in ARGB format. The data in RGB format is obtained by mapping the data in ARGB format by the data sending terminal.

The process of inversely mapping the RGB format data to the ARGB format data by the data receiving terminal is inversely consistent with the process of mapping the ARGB format data to the RGB format data by the data sending terminal, so that the RGB format data can be restored to the ARGB format data.

In the embodiment of the present disclosure, the data sending terminal and the data receiving terminal may be two independent electronic devices, or two chips that communicate with each other in an electronic device, for example, two cascaded Systems-on-Chip (SoCs) in an electronic device.

When a data receiving terminal provided in this disclosure receives the data in RGB format through the second DSI, the data receiving terminal restores the data in RGB format to data in ARGB format. The above data in RGB format received by the data receiving terminal is mapped from data in ARGB format by the data sending terminal. As such, transmission of data in ARGB format through the DSI link is realized. Therefore, the number of interfaces used for sending image display data between the data receiving terminal and the data sending terminal is reduced, and the structures of the data sending terminal and the data receiving terminal are simplified. As a result, more functions can be developed at the data sending terminal and the data receiving terminal.

In some embodiments, the second processor 51 is further configured to, when inversely mapping the data in RGB format to data in ARGB format, convert every 4 pieces of data in RGB format into 3 pieces of data in ARGB format.

In some embodiments, if the ARGB format data obtained from the last 4 pieces of RGB format data have specific value, the second processor 51 will delete the ARGB format data with the specific value.

In some embodiments, the data in ARGB format with specific value include the data in ARGB format with a value of zero.

In some embodiments, after receiving the last 4 pieces of RGB format data, and if the k pieces of ARGB format data at the tail of the converted 3 pieces of ARGB format data have specific value, the second processor 51 will delete (discard) the k pieces of ARGB format data with specific value, where k is less than 3.

The k pieces of ARGB format data having specific value at the tail of the 3 pieces of ARGB format data include the last one of the 3 pieces of ARGB format data having the specific value or the last two of the 3 pieces of ARGB format data having the specific value.

The present disclosure further provides a communication system. The communication system includes the data sending terminal and the data receiving terminal described above, and further includes a transmission link connecting the data sending terminal and the data receiving terminal. The transmission link is configured to transmit data in RGB format.

For simplification purposes, detailed descriptions of the operations of example data sending terminal and data receiving terminal are omitted and references can be made to the descriptions of the example methods.

The above description of the disclosed embodiments enables those having ordinary skills in the art to implement or use the present disclosure. Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A data processing method comprising:
mapping original data in ARGB format into mapped data in RGB format; and
sending the mapped data to a data receiving terminal through a first display serial interface (DSI) for the data receiving terminal to receive the mapped data through a second DSI and to inversely map the mapped data to obtain the original data.

2. The method of claim 1, wherein mapping the original data into the mapped data includes converting every 3 pieces of the original data in ARGB format into 4 pieces of the mapped data in RGB format.

3. The method of claim 2, wherein mapping the original data into the mapped data further includes, in response to a number s of pieces of remaining original data being smaller than 3:
obtaining k pieces of padding ARGB data each having a specific value, k being an integer smaller than 3 and k+s=3; and
converting the k pieces of padding ARGB data and the remaining original data into 4 pieces of RGB data.

4. The method of claim 3, wherein the specific value is zero.

5. The method of claim 3, wherein converting the k pieces of padding ARGB data and the remaining original data into the 4 pieces of RGB data includes:
adding the k pieces of padding ARGB data to an end of the remaining original data to form a 3-piece ARGB data segment with the k pieces of padding ARGB data as a tail of the 3-piece ARGB data segment; and
converting the 3-piece of ARGB data segment into the 4 pieces of RGB data.

6. A data processing method comprising:
receiving mapped data in RGB format sent by a data sending terminal through a first display serial interface (DSI) of the data sending terminal, the mapped data being received through a second DSI of a data receiving terminal; and
inversely mapping the mapped data into original data in ARGB format.

7. The method of claim 6, wherein inversely mapping the mapped data into the original data includes converting every 4 pieces of the mapped data in RGB format into 3 pieces of the original data in ARGB format.

8. The method of claim 7, wherein inversely mapping the mapped data into the original data further includes, in response to last 4 pieces of the mapped data containing data having a specific value, discarding the data having the specific value.

9. The method of claim 8, wherein the specific value is zero.

10. The method of claim 8, wherein discarding the data having the specific value includes, after receiving the last 4 pieces of the mapped data and converting the last 4 pieces of the mapped data into a 3-piece ARGB data segment:
determining whether one or more pieces of ARGB data at a tail of the 3-piece ARGB data segment have the specific value; and
in response to the one or more pieces of ARGB data having the specific value, discarding the one or more pieces of ARGB data.

11. A data sending terminal comprising:
a first display serial interface (DSI); and
a processor coupled to the first SDI and configured to:
map original data in ARGB format into mapped data in RGB format; and
send the mapped data to a data receiving terminal through the first DSI for the data receiving terminal to receive the mapped data through a second DSI and to inversely map the mapped data to obtain the original data.

12. The data sending terminal of claim 11, wherein the processor is further configured to convert every 3 pieces of the original data in ARGB format into 4 pieces of the mapped data in RGB format.

13. The data sending terminal of claim 12, wherein the processor is further configured to, in response to a number s of pieces of remaining original data being smaller than 3:
obtain k pieces of padding ARGB data each having a specific value, k being an integer smaller than 3 and k+s=3; and
convert the k pieces of padding ARGB data and the remaining original data into 4 pieces of RGB data.

14. The data sending terminal of claim 13, wherein the specific value is zero.

15. The data sending terminal of claim 13, wherein the processor is further configured to:
add the k pieces of padding ARGB data to an end of the remaining original data to form a 3-piece ARGB data segment with the k pieces of padding ARGB data as a tail of the 3-piece ARGB data segment; and
convert the 3-piece of ARGB data segment into the 4 pieces of RGB data.

16. A data receiving terminal coupled to a data sending terminal including a first display serial interface (DSI), the data receiving terminal comprising:
a second DSI; and
a processor coupled to the second DSI and configured to:
receive, through the second DSI, mapped data in RGB format sent by the data sending terminal through the first DSI of the data sending terminal; and
inversely map the mapped data into original data in ARGB format.

17. The data receiving terminal of claim 16, wherein the processor is further configured to convert every 4 pieces of the mapped data in RGB format into 3 pieces of the original data in ARGB format.

18. The data receiving terminal of claim 17, wherein the processor is further configured to, in response to last 4 pieces of the mapped data containing data having a specific value, discard the data having the specific value.

19. The data receiving terminal of claim 18, wherein the processor is further configured to, after receiving the last 4 pieces of the mapped data and converting the last 4 pieces of the mapped data into a 3-piece ARGB data segment:
determine whether one or more pieces of ARGB data at a tail of the 3-piece ARGB data segment have the specific value; and
in response to the one or more pieces of ARGB data having the specific value, discard the one or more pieces of ARGB data.

20. A communication system comprising:
the data sending terminal of claim 11, the processor being a first processor;
the data receiving terminal including:
the second DSI; and
a second processor coupled to the second DSI and configured to:
receive the mapped data through the second DSI; and
inversely map the mapped data into the original data; and
a transmission link connecting the data sending terminal and the data receiving terminal, and configured to transmit the mapped data.
